(19) United States
(12) Patent Application Publication
(10) Pub. No.: US 2010/0213626 A1
(43) Pub. Date: Aug. 26, 2010

(54) Diffusion film light diffusion structure molding process and installation thereof

(76) Inventors: Chien-Cheng Lin, Taoyuan County (TW); Shan-Er Hsieh, Taoyuan County (TW); Ying-Yuan Wu, Taoyuan County (TW)

Correspondence Address: Jackson Intellectual Property Group PLLC, 106 Starvale Lane, Shipman, VA, 22971, US

(21) Appl. No.: 11/898,485

(22) Filed: Sep. 12, 2007

(51) Int. Cl. B29D 11/00; B29B 11/06

(52) U.S. Cl. 264/1.1; 425/547

(57) ABSTRACT

A molding process of light diffusion structure on a diffusion film and a molding installation thereof; resin is hot melted into paste state before being extruded into a diffusion film; one or a plurality surface of the diffusion film being rolled to be provided with multiple light diffusion structures corresponding to multiple patterns disposed on the surface of the roller; when streams of light pass through the diffusion film, they are either reflected or diffused by those diffusion structures so to achieve the purposes of light diffusion and uniform diffusion.

### BACKGROUND OF THE INVENTION

(a) Field of the Invention

The present invention is related to a molding process of light diffusion structure on diffusion film, and more particularly, to one that applied in-molding light diffusion structure of diffusion film applied in the backlight module and molding installation thereof.

(b) Description of the Prior Art

TFT-LCD so far a commodity that is more comprehensively as a display is essentially comprised of two members, respectively a display panel and a backlight module to provide light source for the display panel. Depending on the location the light source is disposed the backlight module is available in edge lighting and bottom lighting types. The edge lighting type of the backlight module is usually applied in a display of smaller size with an LED or a cold cathode fluorescent lamp (CCFL) adapted while the bottom lighting type of the backlight module is usually applied in a display of larger size, e.g., a TV set.

In a bottom lighting type of backlight module 1 as illustrated in FIG. 1 of the accompanying drawings, it is comprised of a casing 11 having its inner side coated with a reflective coating that reflects light or attached with a layer of reflective film 12 to reflect a light source; multiple light sources 13 are arranged in sequence at a given gap and a diffuser 14 is disposed over those light sources 13; one or a plurality of light diffusion film 15 and one or a plurality of brightness enhancement film 16 before being combined with a display panel 17 to form a TFT-LCD.

As illustrated, those light sources 13 in the casing 11 when connected through will immediately emit light. Certain portion of the light directly enters into the diffuser 14 while the remaining light is reflected by the reflective film 12 to other positions in the casing 11 before re-entering into the diffuser 14. The light entering into the diffuser 14 is diffused before entering into the light diffusion film 15 for further uniform diffusion of the light source while the BEF 16 executes light collection and gathering; and finally, sufficient and uniform light is supplied to the display panel 17 for use in displaying.

Those diffusion light structures including the diffuser and the light diffusion film are usually made of acrylic, polycarbonate (PC) or acrylic and styrene copolymer (MS) in sheet and are each given a certain light permeability. To attain uniform and diffusion effects of the light source, pigment is added in the manufacturing process to make the diffusion light structure indicating a color of milky white to facilitate diffusion and uniformity of light source. Multiple micro diffusion particles 140 are added as illustrated in FIG. 2 to help light diffusion.

However as illustrated in FIG. 3, multiple diffusion particles 140 are made integrated with the diffuser 14 by uniformly mixing with basic material upon completing the manufacturing of the diffuser 14. Therefore, those diffusion particles 140 are consistently distributed in the diffuser 14, an area directly over each light source 13 becomes brighter for attracting most of the light emitted from the light source. Even though the diffuser 14 has contained multiple diffusion particles, the light diffusion effect is comparatively consistent from any part of the diffuser 14 because those diffusion particles 140 are uniformly distributed in the diffuser 14. The area directly above each light source though being brighter fails to relatively provide better light diffusion effect; rather, it shares the same light diffusion effect with any other area. Accordingly, the brightness at where the diffuser 14 is located directly over each light source becomes too obvious for the display result in general to indicate inconsistent brightness.

In another process, those diffusion particles 140 are directly applied on a surface of the substrate as illustrated in FIG. 4 to form a diffuser 14 with its surface containing multiple diffusion particles. However, the coating method fails to control density of those diffusion particles resulting in poor pavement effect and failure in realizing better and uniform light diffusion results.

### SUMMARY OF THE INVENTION

The primary purpose of the present invention is to provide a molding process of light diffusion structure of a diffusion film applied in a backlight module and molding installation thereof.

To achieve the purpose, resin material is first hot melted into paste state before being extruded into a diffusion film, then one or a plurality of surface of the film is rolled into a light diffusion structure containing multiple light diffusion structures in relation to multiple patterns provided on the roller. Accordingly, when the light passes through the diffusion film, the light diffusion structure reflects or diffuses the light thus to achieve the purpose of consistent uniform diffusion.

Another purpose of the present invention is to provide a molding installation for molding the light diffusion structure of the diffusion film. The installation is essentially comprised of a heating extrusion unit and a roller unit. The heating extrusion unit first has a resin material hot melted into paste state, and then extruded at the discharging end of the extrusion unit. The roller unit placed next to the discharging end of the heating extrusion unit includes a molding roller disposed on a surface of the diffusion film to roll on the diffusion film. Multiple patterns are disposed on a surface of the molding roller for one or a plurality of surface of the diffusion film to form multiple light diffusion structure carrying those multiple patterns. Design of those patterns on the surface of the roller may vary as applicable.

### BRIEF DESCRIPTION OF THE DRAWINGS

FIG. 1 is a schematic view showing a construction of a bottom light backlight module generally available in the market.

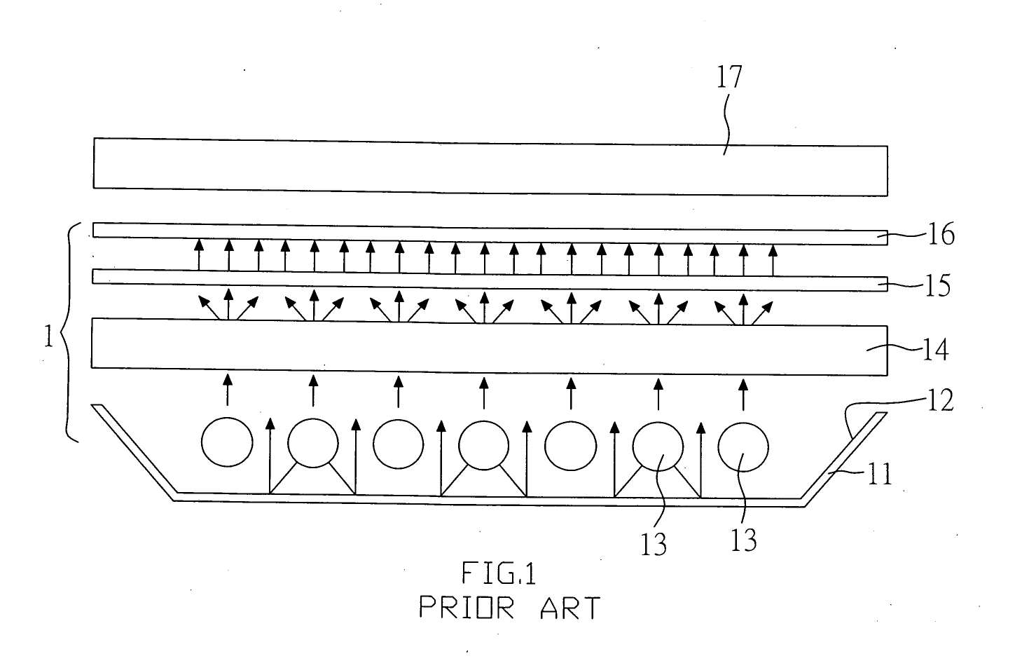

FIG. 2 is a schematic view showing light diffusion by a diffuser of the prior art.

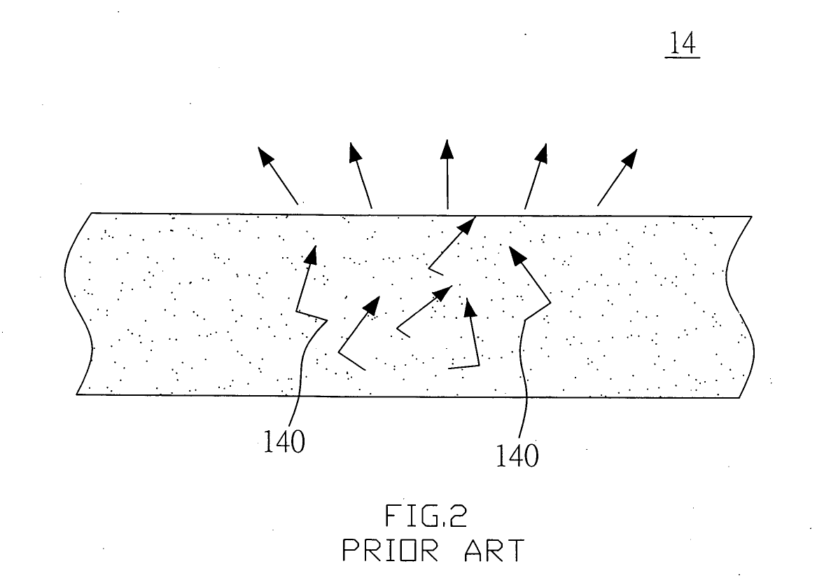

FIG. 3 is a schematic view showing operation of light taken from FIG. 2.

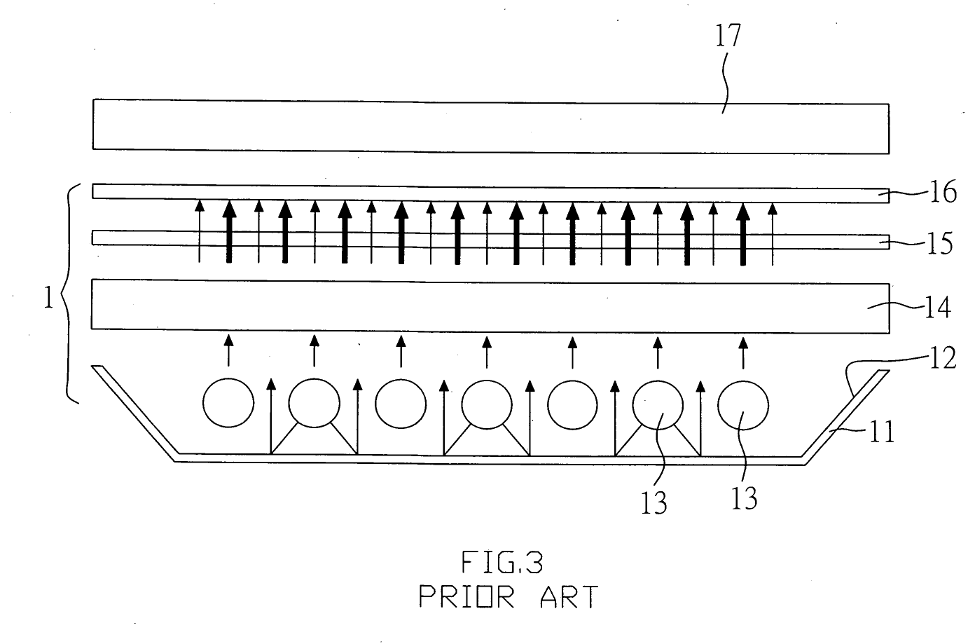

FIG. 4 is a schematic view showing molding of diffusion particles of another diffuser of the prior art.

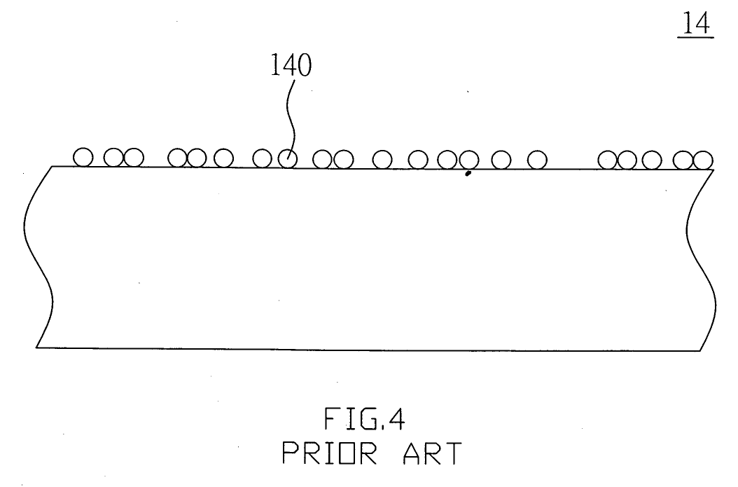

FIG. 5 is a schematic view showing process steps of the present invention for molding light diffusion structure of a diffusion film.

FIG. 6 is a schematic view showing an installation of the present invention for molding light diffusion structure of a diffusion film.

FIG. 7 is a perspective view showing a construction of a roller unit of the present invention.

FIG. 8 is a perspective view showing another construction of the roller unit of the present invention.

FIG. 9 is a perspective view showing a construction of a single molding roller of the present invention.

FIG. 10 is a perspective view showing another construction of the single molding roller of the present invention.

### DETAILED DESCRIPTION OF THE PREFERRED EMBODIMENTS

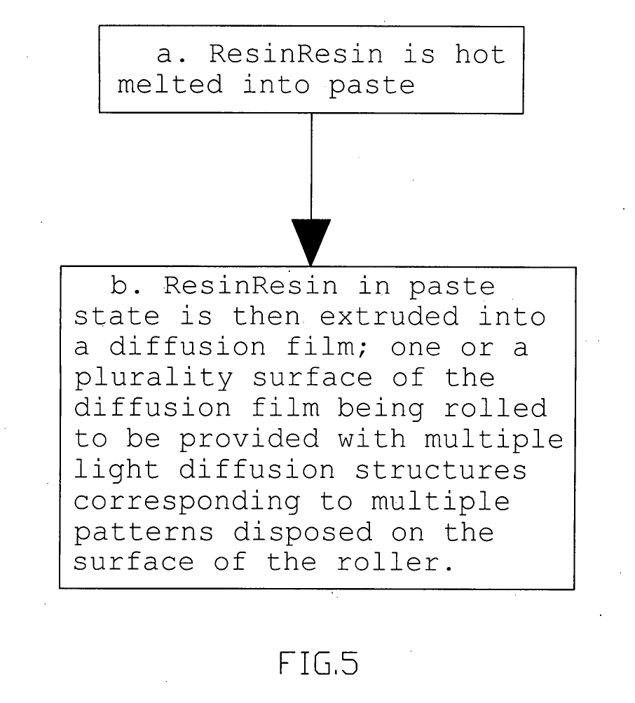

Referring to FIG. 5, a process of the present invention for molding light diffusion structure of a diffusion film is comprised of the following steps:

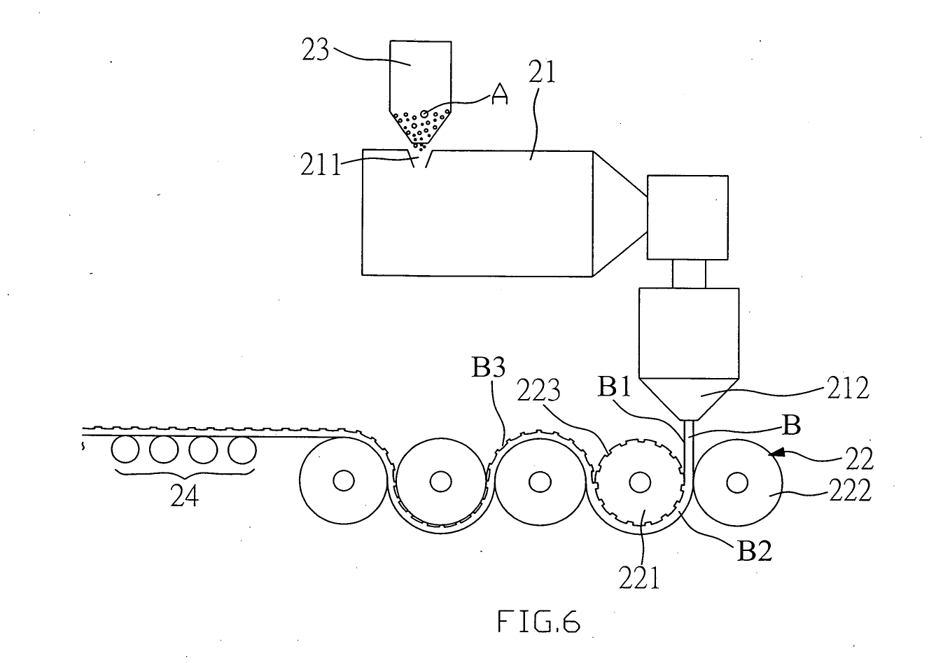

a. A resin material A selected from polymethylmethacrylate (PMMA), Polycarbonate (PC) or Polyethylene terephthalate (PET) that contains multiple particles is hot melted into paste state. A molding installation 2 as illustrated in FIG. 6 contains a heating extrusion unit 21 provided with an feeding end 211 and a discharging end 212 with the feeding end 211 connected to a feeding unit 23 to feed the resin material A from the feeding unit 23 to enter through the feeding end 211 into the heat extrusion unit 21 where the resin material A is hot melted into the paste state.

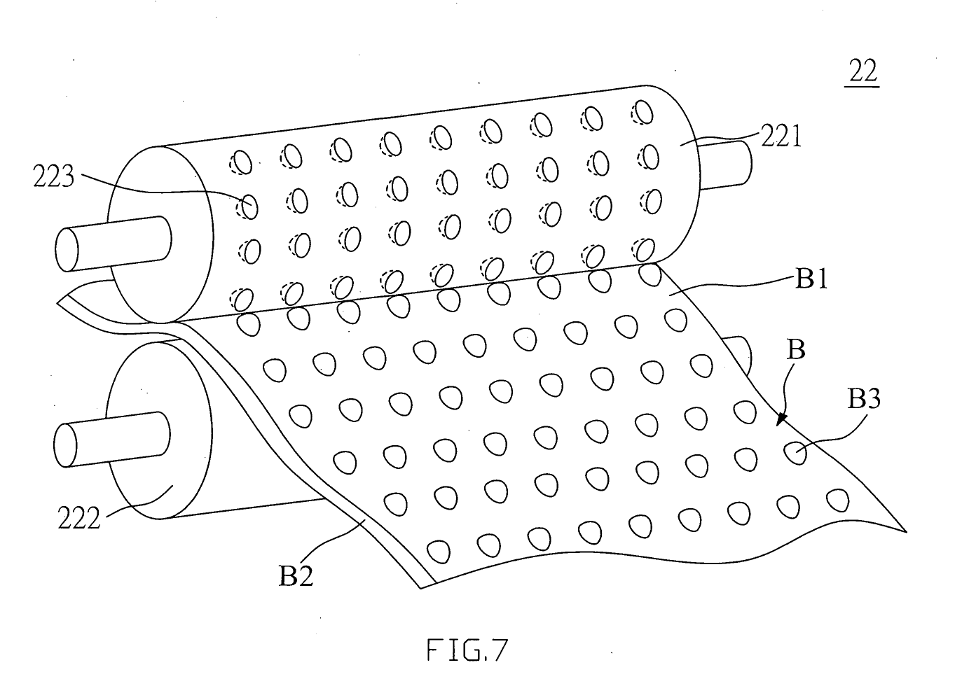

b. The resin material A hot melted into paste state is extruded to form a diffusion film B; the diffusion film B is then rolled by a roller unit 22 disposed next to the discharging end 212 of the heating extrusion unit 21. The roller unit 22 includes one or a plurality of molding roller 221 disposed on a surface B1 of the diffusion film B while a support roller 222 is disposed on another surface B2 of the diffusion film B. A surface of the molding roller 221 is provided with multiple patterns 223 as illustrated in FIG. 7. Those patterns 223 are made integrated with the molding roller 221 with each pattern 223 recessed in or protruding from the surface of the molding roller 221 for the diffusion film B passing through the roller unit 22 to have on its surface B1 provided with multiple light diffusion structures B3 corresponding to those patterns 223.

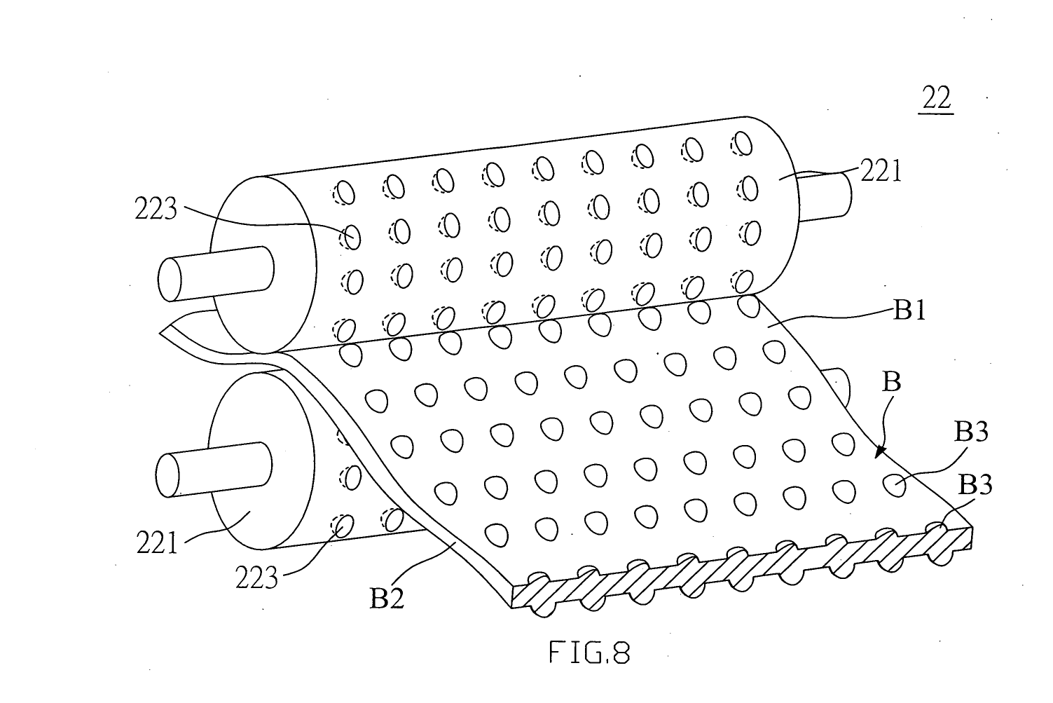

The roller unit 22 as illustrated in FIG. 7 includes the molding roller 221 and the support roller 222 respectively provided to where two surfaces B1 and B2 of the diffusion film B are located for the diffusion film B to be provided with multiple light diffusion structures B3 on one surface; or as illustrated in FIG. 8, the roller unit 22 includes two molding rollers 221 respectively disposed at where both surfaces B1 and B2 of the diffusion film B are located for both surfaces of the diffusion B to be provided with multiple light diffusion structures B3.

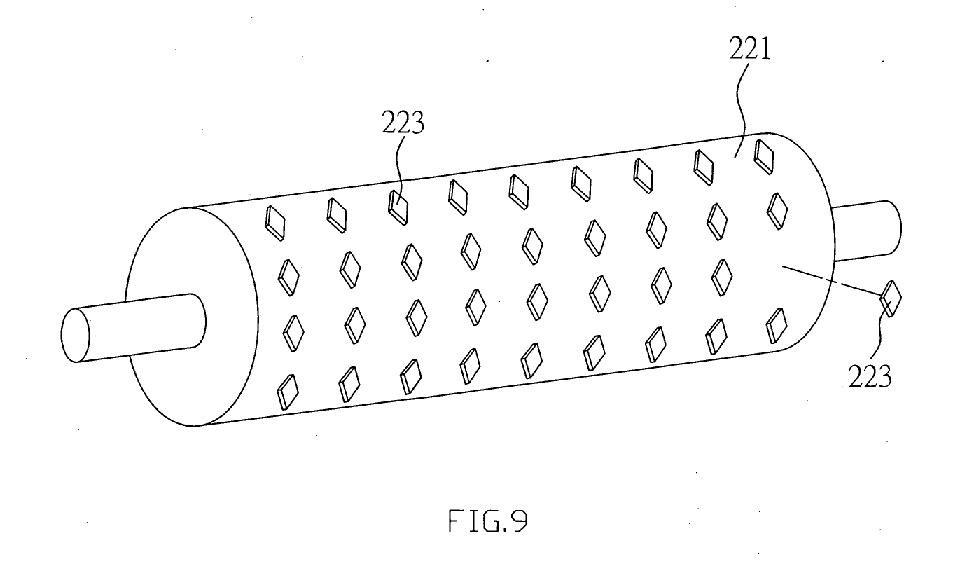

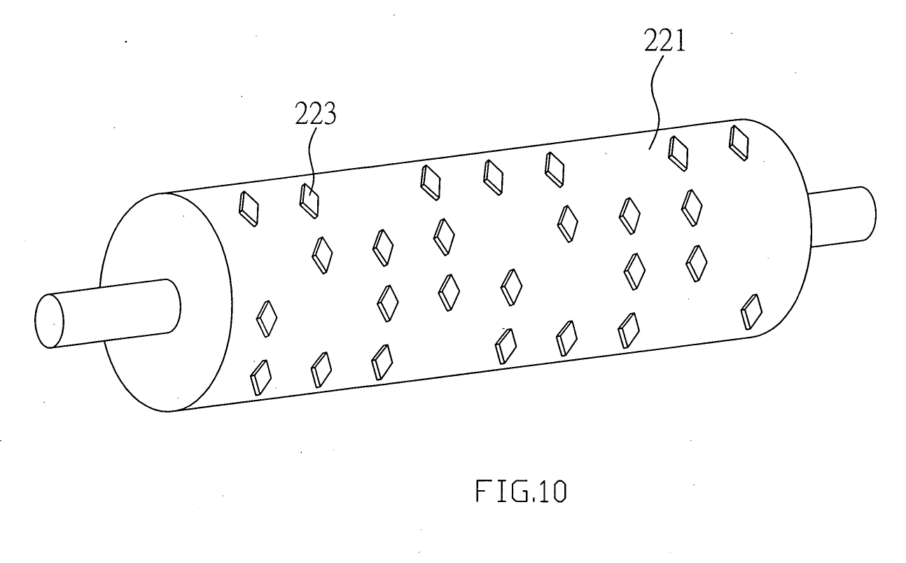

Those patterns may be attached to the molding roller 221 by adhesion as illustrated in FIG. 9 for them to protrude from the surface of the molding roller 221. Those patterns 223 may be arranged in an array as illustrated or not as illustrated in FIG. 10.

Furthermore, a cooling unit 24 is disposed to the roller unit 22 on a side opposite to the heating extrusion unit 21 to harden the already molded diffusion film B.

The molding roller of the present invention may be provided with multiple patterns beforehand to roll on the diffusion film for the diffusion film to be provided with multiple light diffusion structures corresponding to those patterns. When the diffusion film is applied in a backlight module, the light passing through the diffusion film is reflected or diffused by those light diffusion structures to achieve the purpose of light diffusion and uniform di f fusion. The present invention allows control of style or density of those light diffusion structures on the diffusion film by preset multiple patterns

It is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A molding process of light diffusion structure on a diffusion film comprising the following steps:
a. a resin material is hot melted into paste state; and
b. the resin material in paste state is then extruded into a diffusion film and then having one or a plurality of its surface to be rolled by a roller disposed on its surface multiple patterns; the rolled surface of the diffusion film is then provided with multiple light diffusion structures corresponding to those patterns on the roller.

2. The molding process of light diffusion structure on a diffusion film as claimed in claim 1, wherein the resin material is selected from PMMA, PC or PET.

3. The molding process of light diffusion structure on a diffusion film as claimed in claim 1, wherein those multiple patterns are made integrated with the roller.

4. The molding process of light diffusion structure on a di f fusion film as claimed in claim 3, wherein those patterns are disposed recessed in or protruding from a surface of the roller.

5. The molding process of light diffusion structure on a diffusion film as claimed in claim 1, wherein

6. The molding process of light diffusion structure on a diffusion film as claimed in claim 1, wherein those patterns are attached to the roller by adhesion.

7. A molding installation for light diffusion structure on a diffusion film comprising:
a heating extrusion unit, a resin material being hot melted into paste state and extruded into a diffusion film at a discharging end of the heating extrusion unit; and
a roller unit connected next to the discharging end of the heating extrusion unit including one or a plurality of molding rollers disposed at where one surface of the diffusion film is located to roll on the diffusion film; and multiple patterns being disposed on a surface of the molding roller.

8. The molding installation for processing light diffusion structure on a diffusion film as claimed in claim 7, wherein the resin material is selected from PMMA, PC, or PET.

9. The molding installation for processing light diffusion structure on a diffusion film as claimed in claim 7, wherein a feeding end is disposed to the heating extrusion unit; and the feeding end is connected to a feeding unit.

10. The molding installation for processing light diffusion structure on a diffusion film as claimed in claim 7, wherein those patterns are made integrated with the molding roller.

11. The molding installation for processing light diffusion structure on a diffusion film as claimed in claim 10, wherein those patterns are recessed in or protruding from the surface of the molding roller.

12. The molding installation for processing light diffusion structure on a diffusion film as claimed in claim 7, wherein those patterns are recessed in or protruding from the surface of the molding roller.

13. The molding installation for processing light diffusion structure on a diffusion film as claimed in claim 7, wherein those patterns are attached to the molding roller by adhesion.

14. The molding installation for processing light diffusion structure on a diffusion film as claimed in claim 7, wherein a support roller is disposed on where another surface of the diffusion film is located.

15. The molding installation for processing light diffusion structure on a diffusion film as claimed in claim 7, wherein a cooling unit is disposed to the roller unit on one side opposite to the heating extrusion unit.
